(19) United States
(12) Patent Application Publication
(10) Pub. No.: US 2016/0194042 A1
(43) Pub. Date: Jul. 7, 2016

(54) THREE-WHEELED MOBILE ROBOT

(71) Applicants: Keith SCHLEE, Oregeon, WI (US); HELICAL ROBOTICS, LLC, Oregon, WI (US)

(72) Inventor: Keith Schlee, Bradenton, FL (US)

(21) Appl. No.: 14/915,975

(22) PCT Filed: Sep. 4, 2014
(86) PCT No.: PCT/US2014/054156

§ 371 Date: Mar. 2, 2016

Related U.S. Application Data
(60) Provisional application No. 61/873,801, filed on Sep. 4, 2013.

(51) Int. Cl. B62D 61/06; B62D 57/024

(52) U.S. Cl. CPC B62D 61/06; B62D 57/024; Y10S 901/01

(57) ABSTRACT

A three wheeled mobile robot (8) configured to be widely versatile in its use due to its novel drive unit and capability to climb ferrous surfaces regardless of the surface curvature. The drive system is based on three parallel wheels (12, 14, 16) in a fixed orientation capable of approximating the most useful traits of Omni-directional capability while also having the ability to traverse surface obstacles. The robot (8) can also have the ability to scale work surfaces regardless of orientation to the ground or curvature of the surface due to the combination of the three-wheel drive system and magneticadhesion capabilities due to an adjustable onboard magnetic unit (24), which allows the robot to carry on a diverse number of work tasks on all ferrous surfaces via unlimited system integration.

### FIELD OF THE INVENTION

The present invention generally relates to mobile robots. More particularly, this invention relates to a mobile robot design consisting of three wheels.

### BACKGROUND

Three-wheeled robotic chassis and drive trains have existed in industry for decades. In many cases, these designs have been configured to exhibit Omni-directional capabilities. To that end, these machines have often been found to utilize (i) a system of steerable wheels in various configurations, (ii) fixed wheel hubs with Omni-directional capabilities derived from fixed, angled, Omni-wheel designs, or (iii) standard wheels in adjustable, or steerable, angled positions.

Generally, in the case of steerable wheels, one or more wheels of the design have the ability to be oriented independent of, or in conjunction with, one or more other wheels of the design. Such independent/collective orientation of wheels can be found in a multitude of designs, ranging from cars to grocery carts. In more complex designs, each of the wheels is controlled via use of individual motors. For example, FIG. 1 illustrates an exemplary steerable design utilizing three wheels (wheels A, B, and C), each of which is respectively oriented about a pivot point (pivot points A, B, and C) and controlled by a motor (motors A, B, and C).

Conversely, in omni-wheel designs, the wheels are commonly affixed at angled orientations. For example, a design commonly referred to as a Holonomic drive involves three omni wheels affixed in a triangle design. The Holonomic drive is sometimes also referred to as a “fuzzy” drive based on the inherent vibrations and turbulent movement produced by the design. FIG. 2 shows an exemplary Holonomic drive, with the omni wheels (wheels A, B, and C) being generally offset by about 120° from each other.

Known three-wheeled drive systems have been found to exhibit certain limitations, particularly when called upon to climb or maneuver on curved or uneven surfaces (or navigate over surface obstacles). For example, in industrial environments, such curved and/or uneven surfaces can often be encountered when dealing with pipes, tanks, and other industrial structures. To that end, changing orientation of all three wheels in such environments (in order to bring about change in direction) has necessitated complex designs. Such designs have generally not been suited for climbing operations due to increased weight. Furthermore, such designs are generally bulky, which prevent their use in tight spaces, and even if such spaces are navigable, they can be found to adversely affect the wheels of such designs from rotating as needed.

In some applications, systems are needed to navigate against gravity, such as traveling along a vertically-oriented pipe or pole, while also navigating on irregular surfaces. However, the known three-wheeled designs lack the means necessary to attach to curved or irregular surfaces, so as to provide the necessary traction to traverse such surfaces while carrying a load to accomplish useful tasks thereon. For example, regarding Holonomic drive systems, they inherently have low traction, which makes them unsuitable for climbing applications. Furthermore, these systems exhibit difficulty in traversing surface obstacles since at least one wheel is found to be nearly perpendicular to the direction of movement.

### SUMMARY OF CERTAIN EMBODIMENTS OF THE INVENTION

Embodiments of the present invention involve a mobile robot configured to be widely versatile in its use. For example, the mobile robot can be configured for being used on a wide assortment of surfaces, regardless of the orientation and/or shape of the surfaces. Alternatively or in combination, the mobile robot can be configured for effective and efficient movement on the surfaces it traverses.

In certain embodiments, the mobile robot is configured with three wheels that have fixed and parallel orientation that allow stable and constant points of contact with curved and/or uneven surface. Such inherent stability benefits are combined with the robot's ability to move over surface obstacles and on curved and/or irregular surfaces. Omni directional movement of the invention is approximated by differential rotation of the wheels. Furthermore, the direction and orientation of the robot is dynamic based on the speed of travel for each wheel.

In certain embodiments, the mobile robot is configured to be used on a surface, regardless of the surface's orientation with respect to gravity. For example, when designed for use on ferromagnetic surfaces, the robot can include magnets and orientation control structure therefor. In such cases, the magnets are operatively coupled to the robot so as to be held above, i.e., having no direct contact with, the ferromagnetic surfaces, yet the field strengths of the magnets are sufficient to hold the robot and its payload against the surfaces without risk of falling therefrom. In some cases, the magnets are adjustable in two or more dimensions in relation to the ferromagnetic surfaces.

These and other aspects and features of the invention will be more fully understood and appreciated by reference to the appended drawings and the description of the preferred embodiments.

### BRIEF DESCRIPTION OF THE DRAWINGS

The following drawings are illustrative of particular embodiments of the present invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a top view of a known exemplary steerable wheel design;

FIG. 2 is a top view of a known exemplary Holonomic drive system;

FIG. 3 is a bottom view of the mobile platform design in accordance with certain embodiments of the invention;

FIG. 4 is a top view of the mobile platform design of FIG. 3;

FIG. 5 is a top view of another mobile platform design with exemplary payload in accordance with certain embodiments of the invention;

FIG. 6 is a perspective view of the mobile platform design of FIG. 5 as shown traversing a curved work surface in accordance with certain embodiments of the invention;

FIG. 6A is an enlarged view of a portion of FIG. 6 with respect to the mobile platform design;

FIG. 7 is a photograph showing the mobile platform design of FIG. 5 as shown in event of traversing between flat surface and curved surface in accordance with certain embodiments of the invention; and

FIG. 8 is a photograph showing the mobile platform design of FIG. 5 as shown in event of traversing between flat surfaces of differing angles in accordance with certain embodiments of the invention.

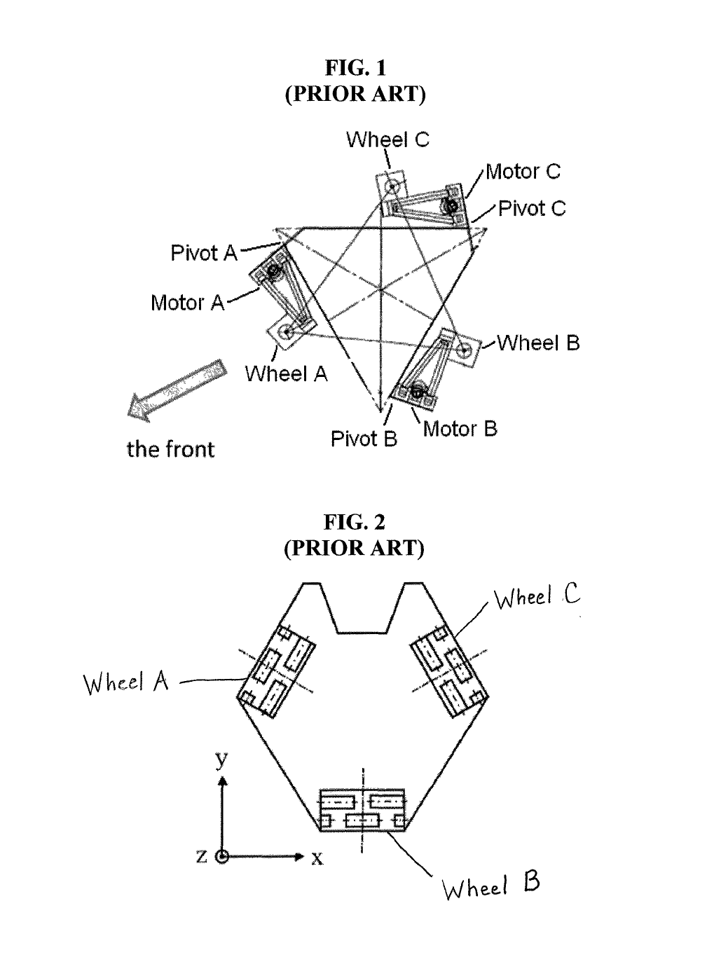

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and other elements employ that which is known to those of ordinary skill in the field of the invention. Those skilled in the art will recognize that many of the noted examples have a variety of suitable alternatives.

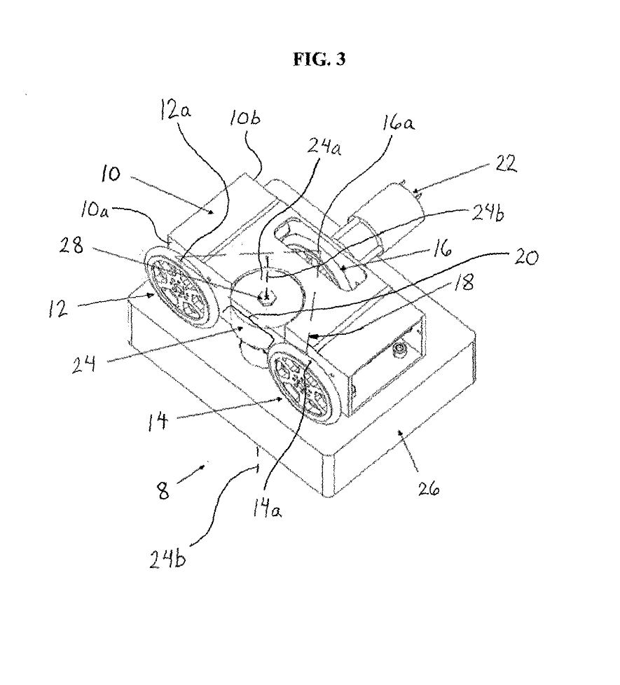

FIG. 3 shows a mobile platform 10 in accordance with certain embodiments of the invention. As shown, the mobile platform 10 is part of a mobile robot 8, with the platform 10 forming a chassis (for the robot 8) and consisting of three wheels 12, 14, and 16 (such as polyurethane wheels) operatively coupled thereto. As shown, the wheels 12, 14, and 16 are shown to be of similar size. Further, the wheels 12, 14, and 16 are of a similar type, e.g., standard wheel design; however, the invention should not be limited to such. For example, one or more of the wheels can be of Omni-directional design. As shown, two of the wheels 12 and 14 are operatively coupled to one side 10a of the platform 10, while the third wheel 16 is operatively coupled to the opposing side 10b of the platform 10.

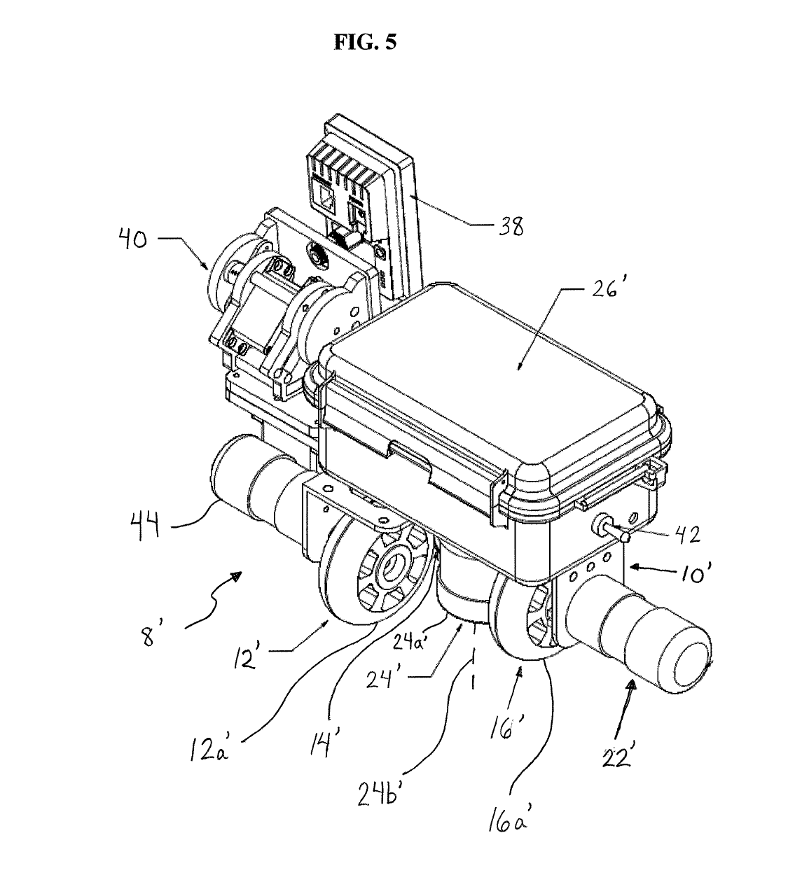

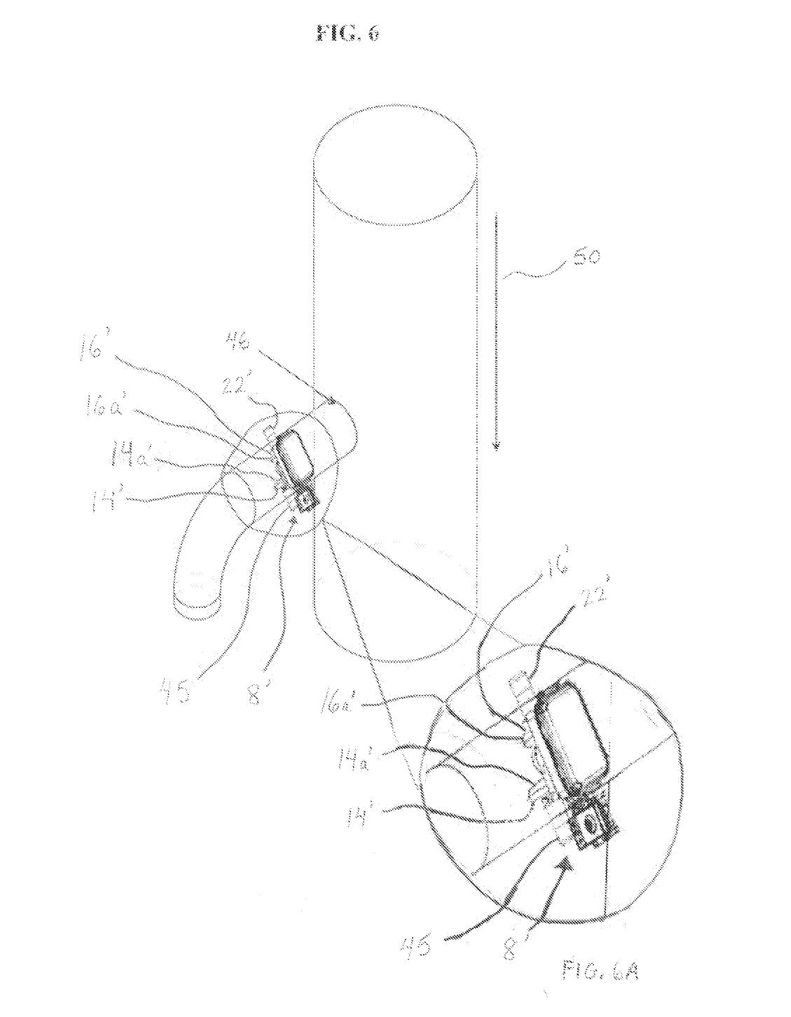

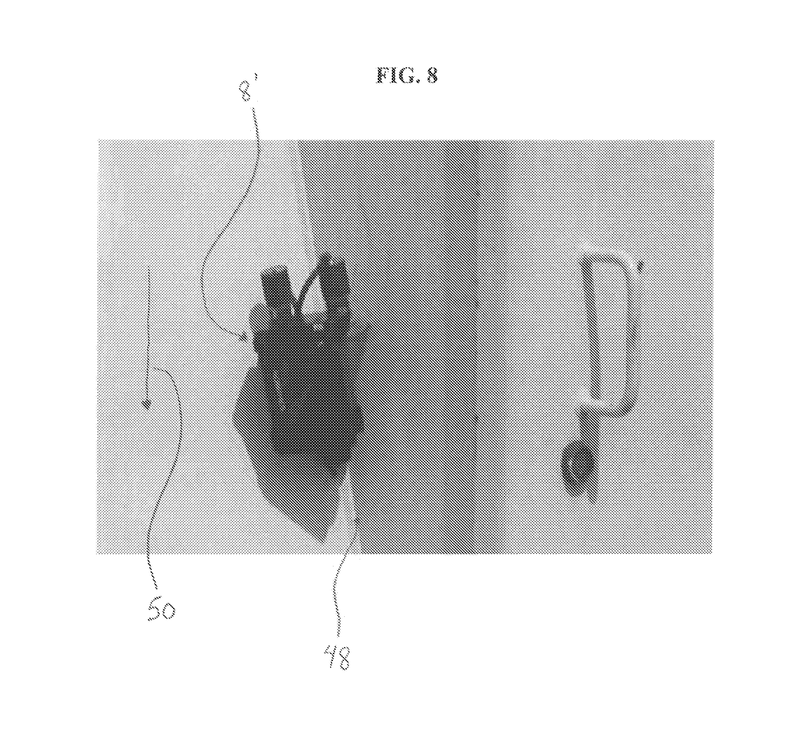

In certain embodiments, as shown, each of the wheels 12, 14, and 16 have fixed orientation relative to the opposing sides 10a, 10b of the platform 10, such that the wheels are each oriented in parallel directions. As further illustrated, in certain embodiments, the wheels 12 and 14 are spaced apart on the platform side 10a, yet aligned relative to each other in front-to-back manner. Conversely, the third wheel 16 is positioned along the opposing platform side 10b, so as to be centered relative to the other two wheels 12 and 14, thereby being equidistant from the first and second wheels 12 and 14. As shown, the wheels 12, 14, and 16 are distributed about the platform 14 so as to define a plane 18 there between, defined to be the shape of a triangle, with contact points 12a, 14a, and 16a (for contacting work surface) for each wheel 12, 14, and 16, respectively, representing points of the triangle. As shown, in certain embodiments, the spacing (or space 20) between the wheels 12 and 14 is of an extent substantially similar to diameter of the third wheel 16; however, this can vary with certain modifications being made to the robot, as further detailed herein with reference to FIGS. 5-8. Further, in certain embodiments as shown, one or more of the wheels 12, 14, and 16 (e.g., the third wheel 16 as shown) can be operatively coupled to an interior surface of the platform 10.

The benefit of such triangular and closely-positioned locations of the wheels 12, 14, and 16, whereby only three points of contact 12a, 14a, and 16a are facilitated (for contacting a work surface being traversed), is that all of the wheels 12, 14, and 16 are always in contact with the surface, regardless of the surface's shape or geometry, e.g., whether curved or uneven. In addition, by maintaining the fixed parallel orientation of the wheels 12, 14, and 16, the robot 8 dictates a compact footprint and more reliable operating abilities, while providing maximum traction for climbing.

In certain embodiments, each of the wheels 12, 14, and 16 are powered via respective motors, e.g., 12 volt brushed DC motors. With further reference to FIG. 3, while one such motor 22 is shown as extending from wheel 16, it should be appreciated that other motors extending from each of the wheels 12 and 14 are located internal to the platform (or chassis) 10 and hidden from view. In certain embodiments, as shown, the motors are oriented perpendicular to the wheel direction of travel, but the invention should not be limited to such. For example, the orientation of the motors may vary with changes to configuration of the platform 10 and corresponding gearbox configuration.

Turning of the robot 8 is accomplished via differential rotation of the wheels 12, 14 on the platform (left) side 10a and wheel 16 on the opposing platform (right) side 10b. All three wheels 12, 14, and 16 being driven clockwise (CW) or counterclockwise (CCW) results in the platform 10 moving forward or reverse respectively. Conversely, moving the wheels 12 and 14 (on platform left side 10a) counterclockwise (CW) and the wheel 16 (on platform right side 10b) counterclockwise (CCW) causes the platform 10 to rotate clockwise (CW). Likewise, reversing the wheel motion causes the platform to rotate counterclockwise (CCW) about a fixed point. Such movement of the robot 8 is summarized in Table 1 below.

TABLE 1

| Direction of Movement | Wheel Actuation |
|---|---|
| Rearward (AFT) | All Wheels CCW Same Speed |
| Forward | All Wheels CW Same Speed |
| CW Rotate | Left Wheels CW; Right Wheel CCW |
| CCW Rotate | Left Wheels CCW; Right Wheel CW |

In certain applications, the mobile robot 8 may need to rotate in tight spaces. As such, in certain embodiments as noted above, one of the wheels 12 or 14 may be replaced with an Omni wheel. Such substitution would allow slippage of rollers of the Omni wheel, while still maintaining 3 points of contact with the surface being traversed. In such embodiment, the two wheels of standard type (the other of wheels 12 and 14, as well as wheel 16) maintain sufficient traction (create friction) with underlying surface(s) to keep the robot 8 stable during climbing operations, even when the Omni wheel rollers are free to roll in the direction of gravity.

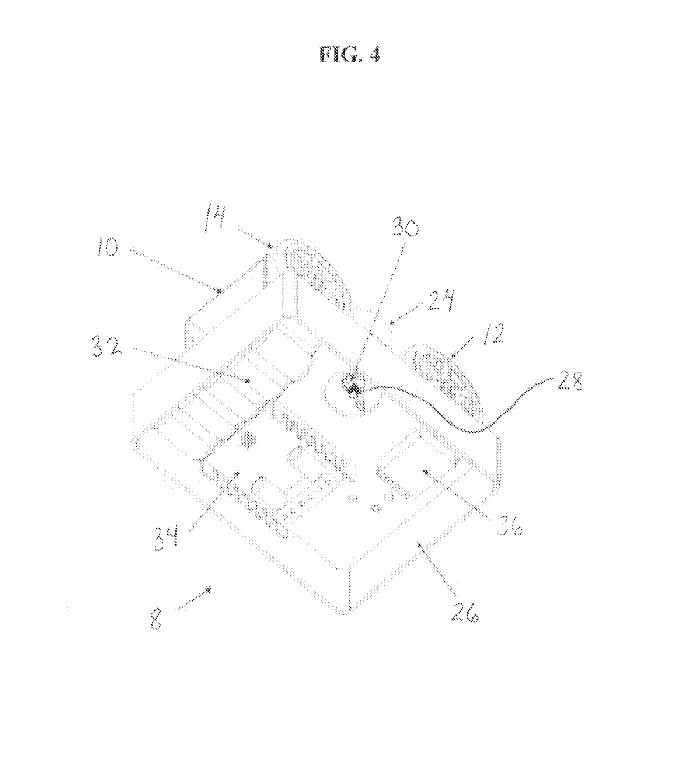

Continuing with FIG. 3, the platform 10 is shown to include a magnet 24, such as a neodymium magnet. With reference to FIG. 4, showing a top view of the robot 8, the magnet 24, in certain embodiments, can be operatively coupled to an enclosure 26 of the robot 8 such that its lower surface 24a is suspended slightly above a ferrous surface to allow the platform to drive in any direction and in any orientation on such a work surface. To that end, the magnet 24 is held relative to lower surface 10c of the platform 10, while being offset from work surface being traversed by robot 8, to prevent contact with such surface and corresponding friction there between.

In certain embodiments, the magnet 24 is adjustably coupled to the robot enclosure 26. It should be appreciated that such adjustable coupling can take a variety of forms. For example, with reference to FIG. 3, the magnet 24 is operatively coupled to the robot enclosure 26 via an adjustment bolt 28, whereby the height of the magnet lower surface 24a relative to the work surface can be adjusted via tightening/loosening of corresponding screw 30 (see FIG. 4) on bolt 28. Thus, the gap between the magnet 24 and the work surface can be varied based on the particular work surface. Additionally, in certain embodiments, the magnet lower surface 24a can be angularly shifted relative to the work surface via various means. While the robot 8 is shown with only one magnet 24, the invention should not be so limited, as more magnets can be added so long as their location(s) comply with the description below.

Continuing with FIG. 3, in certain embodiments as shown, the magnet 24 has a central axis 24b (shown as dashed line) that extends through the plane 18 defined between the wheel contact points 12a, 14a, and 16a. Such extension of the magnet central axis 24b through the plane results in corresponding forces from the magnet 24 being exerted on the three wheels 12, 14, and 16 sufficient to maintain contact with a work surface of ferromagnetic material, regardless of varying shape of such surface or orientation of the robot 8 when navigating such surface. As shown, the magnet 24 is situated so as to be centered between the two wheels 12, 14 on platform side 10a (and in line with the wheel 16 on opposing platform side 10b). To that end, in certain embodiments, the magnet 24 can be spaced equally between the wheels 12, 14, and 16 to equalize the downward force of the magnet on all three of the wheels 12, 14, and 16. However, such equal spacing of the magnet 24 is not required, so long as the central axis 24b of the magnet 24 is situated within plane defined between the wheel contact points 12a, 14a, and 16a. Such configuration for the magnet 24 relative to the wheels 12, 14, and 16 provides an ideal center of gravity, which would provide for sufficient stresses on the wheel motors so the mobile platform tracks straight. To that end, if, for example, position of the magnet 24 were to be instead shifted toward one of the wheels (e.g., wheel 16) yet within plane between wheels 12, 14, and 16, the corresponding motor (e.g., motor 22) for such wheel would need to work harder to keep the platform 10 (and robot 8) driving straight, and such would lag behind other wheel motors (e.g., of platform side 10a) if there were no control compensation.

Continuing with the above, if the magnet 24 were positioned outside the position described above, the platform 10 would still function as long as the magnet 24 is located within the triangle 18 drawn between (contact points of) each of the three wheels 12, 14, and 16 (see FIG. 3). To that end, if the magnet 24 were located outside this triangle 18, one of the wheels 12, 14, and 16 would not have any positive force exerted on it, and it would be possible for the platform 10 (and robot 8) to foreseeably shift on two of the three wheels 12, 14, and 16, thereby becoming temporarily inoperable. Particularly, the magnetic force created would overwhelm the center of gravity location for stability on ferrous surfaces, so the center of gravity could fall slightly outside the triangle 18 in this situation.

Turning back to FIG. 4, in certain embodiments as described above, the platform 10 supports an enclosure 26 for the robot 8. Such enclosure 26, in certain embodiments, is used for housing electronic controls for the robot 8. For example, such controls can include power source 32, such as one or more batteries, and a controller 34, e.g., for controlling motor speed, which in certain embodiments, is further controlled by an electronic receiver 36. In such embodiment, all controls are operated wirelessly with an electronic controller (e.g., located remote from robot 8 and configured to wirelessly communicate with receiver 36). In alternate applications, wireless communication may not be available. In such applications, the electronic controller can be further located in enclosure 26 and part of a wired design allowing for control of the robot 8.

It should be understood that various payloads and control sensors may be operatively coupled to the mobile platform 10 so as to perform various tasks. To that end, while only baseline components for operation are depicted in FIGS. 3 and 4, the invention should not be so limited. Furthermore, the configurations of these baseline components can be altered as desired, while still abiding by the design requirements regarding wheels 12, 14, 16 and magnet 24 already detailed herein.

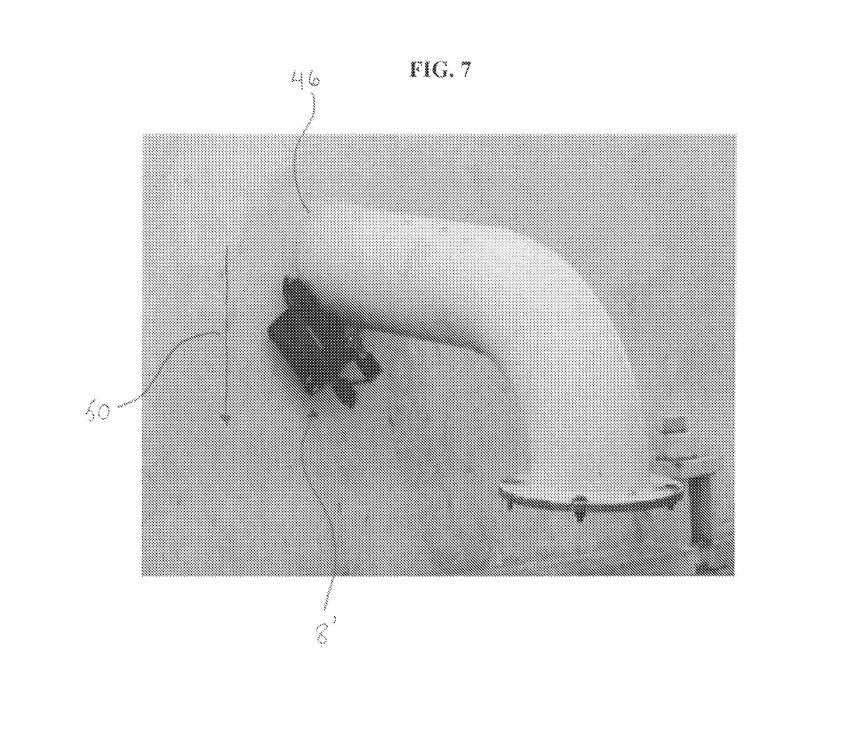

For example, FIG. 5 shows another mobile platform 10′ (of further robot 8′) with exemplary payload (shown as wireless camera 38 and pan/tilt system 40) in accordance with certain embodiments of the invention. As shown, the enclosure 26′ (e.g., for the electronic controls with optional external power switch 42) has been reduced in size (compared to enclosure 26 of robot 8), whereby orientation of the motors for wheels 12′ and 14′ (wheel 12′ and corresponding motor 44 being shown, while wheel 14′ and corresponding motor 45 are mostly hidden in FIG. 5, but shown in FIG. 6) can be altered to allow the two wheels 12′ and 14′ to be spaced closer together, so as to correspondingly enable the wheels 12′, 14, and 16′ to be collectively positioned closer to (and more closely surround) the magnet 24′ (with reduced spacing between the magnet's central axis 24b′) . It should be appreciated that the configuration of contact points 12a′, 14a′, and 16a′ of the wheels 12′, 14′, and 16′ (and corresponding center of gravity center) as well as parallel setup for the wheels 12′, 14′, and 16′ are similar to that already described with regard to robot 8; however, the above-described design modifications (facilitating closer positioning of the wheels 12, 14′, and 16′ relative to the magnet 24′) of the robot 8′ enhance its performance. For example, such configuration enables the robot 8′ to bump into protruding objects (e.g. walls and pipes) and subsequently transition over them. In certain embodiments, via such configuration, the robot 8′ is able to transition between surfaces having angular difference of up to 135° (e.g., traversing from horizontal surface of 0° to vertical surface of 90° plus 45° additional angular difference) while its wheels 12′, 14′, and 16′ provide continual contact with the surfaces.

Transitioning between such surfaces with such severe angular difference, even when against gravity, is made possible (based on the combination of the further protruding wheels 12′ and 14′ and the altered three-wheel geometry), which permits the magnet 24′ to remain in close proximity to the work surface when making such transition. To that end, FIGS. 6-8 illustrate differing transition environments (and differing transition angles 46 and 48) for such robot 8′, e.g., between differing angled surfaces, whether one flat and the other curved, or both being flat, despite gravitational force 50 acting upon the robot 8′.

The advantages of the present invention overcome many of the limitations of known three-wheeled machines. Particularly, the mobile platforms 10, 10′ (of corresponding robots 8, 8′) allow contact by all wheels regardless of surface orientation. The parallel wheel design for the platforms 10, 10′ also provide an accurate and compact way to approximate Omni-directional capabilities without additional mechanical design or bulk involved in wheel hubs which require turning capabilities.

Thus, embodiments of a THREE-WHEELED MOBILE ROBOT are disclosed. While the foregoing written description of the invention enables one of ordinary skill to make and use what is considered presently to be the best mode thereof, those of ordinary skill will understand and appreciate the existence of variations, combinations, and equivalents of the embodiments (and examples thereof) described herein. To that end, one skilled in the art will appreciate that the invention can be practiced with embodiments other than those disclosed. The disclosed embodiments are presented for purposes of illustration and not limitation, and the invention is limited only by the claims that follow.

What is claimed is:

1. A mobile robot, comprising:
a platform; and
three wheels situated about the platform and configured to serve as continual points of contact for the mobile robot when used in traversing a work surface of any shape;
wherein a first and a second of the wheels are operatively coupled on one side of the platform, and a third of the wheels is operatively coupled on an opposing side of the platform, the three wheels having fixed orientations and being oriented in parallel directions.

2. The mobile robot of claim 1 wherein the three wheels are each of similar size and type, wherein the three wheels are configured to make continual contact with surfaces that are curved and uneven.

3. The mobile robot of claim 1 wherein one of the first and second wheels is of Omni-directional design to enhance rotation capability of the one wheel.

4. The mobile robot of claim 2 wherein the first and second wheels are aligned on the one side of the platform in front-to-back manner, and wherein the third wheel is positioned on the opposing side of the platform such that the contact point of the third wheel is spaced from the contact points of the first and second wheels by first and second distances, respectively.

5. The mobile robot of claim 4 wherein the first and second distances are a same distance.

6. The mobile robot of claim 2 further comprising a magnet operatively suspended relative to the platform so as to define a gap between a lower surface of the magnet and the work surface, the magnet adapted to hold the robot and a corresponding payload thereof against work surfaces of ferromagnetic material when the robot is traversed thereon and regardless of orientation of such surfaces to ground or floor.

7. The mobile robot of claim 6 wherein the magnet has a central axis that extends through a plane defined between the contact points of the three wheels, wherein extension of the magnet central axis through the plane results in corresponding forces from the magnet being exerted on the three wheels and sufficient to maintain the contact points of the three wheels when the mobile robot is traversed on work surfaces of ferromagnetic material regardless of shape of such surfaces.

8. The mobile robot of claim 7 further comprising a separate motor for each of the wheels, and wherein the central axis of the magnet is equidistant from each of the contact points of the three wheels such that the separate motors are configured to be stressed equally during corresponding rotations of the three wheels along work surfaces of ferromagnetic material.

9. The mobile robot of claim 7 further comprising a separate motor extending from each of the wheels, wherein the motors protrude away from the platform, thereby enabling minimized spacing between the three wheels and the magnet, whereby such minimized spacing corresponds to the mobile robot being configured to transition over obstacles encountered on the work surface.

10. The mobile robot of claim 9 wherein the plane is defined in a shape of a triangle, wherein the shape of the triangle is minimized about the magnet, whereby the three wheels are configured to maintain their points of contact with the work surface while transitioning over portions of the work surface having angular difference of up to 135°.

11. A mobile robot, comprising:
a platform;
three wheels situated about the platform and configured to serve as continual points of contact for the mobile robot while traversing a work surface of any shape; and
a magnet operatively suspended relative to the platform so as to define a gap between a lower surface of the magnet and the work surface, the magnet adapted to hold the robot and a corresponding payload thereof against work surfaces of ferromagnetic material when the robot is traversed thereon and regardless of orientation of such surfaces to ground or floor.
wherein the three wheels have fixed orientations and are oriented in parallel directions, and wherein the magnet has a central axis, wherein such axis extends through a plane defined between the contact points of the three wheels, the plane defined in shape of a triangle.

12. The mobile robot of claim 11 wherein the central axis of the magnet has differing spacing with one or more of the points of contact of the three wheels, wherein extension of the magnet central axis through the triangle-shaped plane results in corresponding forces from the magnet being exerted on the three wheels and sufficient to maintain the contact points of the three wheels when the mobile robot is traversed on work surfaces of ferromagnetic material regardless of shape of such surfaces.

13. The mobile robot of claim 11 wherein the first and second wheels are aligned on one side of the platform in front-to-back manner, and wherein the third wheel is positioned on an opposing side of the platform such that the contact point of the third wheel is equidistant from the contact points of the aligned first and second wheels.

14. The mobile robot of claim 11 further comprising a separate motor for each of the wheels, and wherein the central axis of the magnet is equidistant from each of the contact points of the three wheels such that the separate motors are configured to be stressed equally during corresponding rotations of the three wheels along work surfaces of ferromagnetic material.

15. The mobile robot of claim 11 further comprising a separate motor extending from each of the wheels, wherein the motors protrude away from the platform, thereby enabling minimized spacing between the three wheels and the magnet, whereby such minimized spacing corresponds to the mobile robot being configured to transition over obstacles encountered on the work surface.

16. The mobile robot of claim 15 wherein the triangle-shaped plane is minimized about the magnet, whereby the three wheels are configured to maintain their points of contact with the work surface while transitioning over portions of the work surface having angular difference of up to 135°.

17. The mobile robot of claim 11 wherein the magnet is adjustable in two or more dimensions in relation to the work surfaces of ferromagnetic material.

18. The mobile robot of claim 17 wherein the magnet is adjustable with regard to angle and clearance in relation to the work surfaces of ferromagnetic material.

19. The mobile robot of claim 11, wherein the magnet comprises a plurality of magnets operatively suspended relative to the platform so as to define corresponding gaps between a lower surface of the magnet and the work surface.

20. A mobile robot, comprising:
a platform; and
three wheels situated about the platform and configured to serve as continual points of contact for the mobile robot while traversing a work surface of any shape;
a magnet operatively suspended relative to the platform so as to define a gap between a lower surface of the magnet and the work surface, the magnet adapted to hold the robot and a corresponding payload thereof against work surfaces of ferromagnetic material while the robot is traversed thereon and regardless of orientation of such surfaces to ground or floor; and
separate motors for each of the three wheels;
wherein the three wheels have fixed orientations and are oriented in parallel directions, wherein the magnet has a central axis, wherein such axis extends through a plane defined between the contact points of the three wheels and in shape of a triangle, and wherein the motors extend from each of the wheels and protrude away from the platform, enabling a minimized size of the triangle-shaped plane and minimized spacing between the three wheels and the magnet, whereby such minimized spacing corresponds to the mobile robot being configured to transition over obstacles encountered on the work surface.
